(19) United States
(12) Patent Application Publication
(10) Pub. No.: US 2007/0225908 A1
(43) Pub. Date: Sep. 27, 2007

(54) Mobile terminal and method for DMB-based navigation

(75) Inventors: Jong Hyun Kim, Suwon-si (KR); Jin Won Kim, Seoul (KR); Kwang Soo Kim, Seoul (KR); Hyun Suk Min, Suwon-si (KR); Sung Chul Yang, Suwon-si (KR); Suk In Jung, Seoul (KR); Hye Jung Yang, Busan-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/707,762

(22) Filed: Feb. 16, 2007

(30) Foreign Application Priority Data
Mar. 24, 2006 (KR) 2006-0026888

(51) Int. Cl. G01C 21/30; G01C 21/32

(52) U.S. Cl. 701/210; 701/211

(57) ABSTRACT

A mobile terminal executes a navigation function by receiving Transport Protocol Experts Group (TPEG) traffic information through a Digital Multimedia Broadcasting (DMB) network. This DMB-based mobile terminal receives and decodes TPEG data at a separate second processor different from a conventional first processor. Further, the DMB-based mobile terminal may execute a calculation of an optimum route at the second processor. The terminal and a related method reduce the processing load of the first processor, which causes a decrease in the response time to a user's navigation request and improves a user's convenience.

### PRIORITY

This U.S. non-provisional application claims priority under 35 U.S.C. §119 from Korean Patent Application No. 2006-26888, which was filed in the Korean Intellectual Property Office on Mar. 24, 2006, the contents of which are incorporated herein by reference.

### BACKGROUND OF THE INVENTION

1. Field of the Invention

The present invention relates generally to Digital Multimedia Broadcasting (DMB)-based navigation technology and, more particularly, to a mobile terminal and a method for executing a navigation function while receiving Transport Protocol Experts Group (TPEG) traffic information through a DMB network.

2. Description of the Related Art

DMB technology, which combines broadcasting with communication, has recently become popular in the art of wireless telecommunications. The DMB technology modulates various multimedia signals such as voices and images in a digital manner, and offers the multimedia digital signals to portable or car-equipped receivers, thus often referred to as “a TV in hands”. The current DMB service is based on a digital audio broadcasting (DAB) technology which was previously developed for digital radio, and expands in a multimedia broadcasting area which enables transmission of motion pictures and various data related to such topics as weather, news, stock and traffic. Particularly, even while a user is in motion, the DMB service enables the user to enjoy high-quality broadcasting comparable to that from a compact disc (CD) or a digital video disc (DVD) through a portable or car-equipped terminal. In this manner, DMB technology is a next generation broadcasting technology.

There has also been developed a next generation navigation service employing a TPEG technology, which allows transmission of real-time traffic information as a DMB data service along with DMB signals. TPEG is well known as an international standard protocol for transmission of traffic or travel information through digital media.

FIG. 1 is a block diagram of a conventional mobile terminal for DMB-based navigation. As shown in FIG. 1, the conventional mobile terminal 10 includes a processor 11 for executing a navigation application, a display output unit 12, a data input unit 13, a position determination unit 14, a memory unit 15, a TPEG receiving unit 16, a TPEG decoding unit 17 and an optimum route calculation unit 18.

The processor 11 controls the operation of a variety of components in the terminal 10. The display output unit 12 provides visual information such as map data on a screen. The data input unit 13 receives user's operation as input signals. The position determination unit 14 determines a user's current position by using a global positioning system (GPS) as is well known in the art. The memory unit 15 saves various data including map data, TPEG data and input data by a user. The TPEG receiving unit 16 receives TPEG data from among DMB data. The TPEG decoding unit 17 decodes the received TPEG data. The optimum route calculation unit 18 calculates an optimum route by using the TPEG data.

FIG. 2 illustrates a conventional method for executing navigation using the terminal in FIG. 1. Referring to FIGS. 1 and 2, at the outset of navigation, the TPEG receiving unit 16 receives real-time DMB data repeatedly transmitted (S11), and then determines whether the received DMB data is TPEG data (S12). If the received DMB data is not TPEG data, then steps S11 and S12 are repeated. If the received DMB data is TPEG data, the TPEG receiving unit 16 transmits the TPEG data to the processor 11 (S13), which determines whether to finish the navigation (S14). If the determination is “yes”, the navigation ends. If the determination is “no”, then steps S11 to S14 are repeated.

As discussed above, the processor 11 receives the TPEG data sent by the TPEG receiving unit 16 (S15). Then the TPEG decoding unit 17 decodes the received TPEG data (S16), and the memory unit 15 stores the decoded TPEG data (S17).

At the outset of the navigation, the processor 11 processes a user's input transmitted from the data input unit 13 or executes a route guiding operation (S18). Additionally, the processor 11 determines whether to calculate an optimum route (S19). If the determination is “yes”, the optimum route calculation unit 18 executes the calculation by using the TPEG data stored in the memory unit 15 (S20). After the calculation, or if the determination is “no”, the processor 11 determines whether to finish the navigation (S21). If the determination is “yes”, the navigation ends. If the determination is “no”, then steps S18 to S21 are repeated.

As discussed above, the conventional mobile terminal and the related navigation method use only one processor 11 for executing the navigation application. This processor 11 performs a variety of functions such as TPEG data reception, periodic decoding and storing of TPEG data, user input processing, route guidance and calculation of the optimum route.

TPEG data includes real-time traffic information including link ID information about roads in a target area for service and speed information about each link. Such real-time traffic information is renewed continuously at regular intervals. Real-time receiving and decoding of TPEG data may cause an excessive processing load of the processor that executes the navigation application.

Furthermore, to perform the route guidance for a user, the processor determines the user's current position in a GPS cycle, updates the map data on the current position and changes a user interface (UI) by altering a voice or a graphic display. In addition, at a user's request the processor calculates the optimum using TPEG data. The processor is therefore heavily burdened with an excessive processing load.

Accordingly, the conventional mobile terminal and the related navigation method has drawbacks of, for example, an unfavorable time delay in response to user's navigation requests such as the route guiding operation and the optimum route calculation, as well as user's inconvenience incurred by the delayed response.

### SUMMARY OF THE INVENTION

The present invention discloses a mobile terminal and a method for executing a DMB-based navigation, which decrease a response time to a user's navigation request and improve a user's convenience by reducing a processing load of a processor that executes a navigation application.

According to the present invention, a DMB-based navigation mobile terminal includes a data input unit that receives input signals through user's operation, a position determination unit that determines a user's current position, a memory unit that stores map data, and a first processor that processes the input signals and controls a route guiding operation. The terminal further includes a TPEG receiving unit that receives TPEG data, a TPEG decoding unit that decodes the TPEG data, a second processor that controls the receiving of the TPEG data and the decoding of the TPEG data, and a display output unit that exhibits the user's current position and the map data under the control of the first controller.

The terminal of the present invention further includes an optimum route calculation unit that is controlled by the first processor and calculates an optimum route by using the decoded TPEG data. Alternatively, the terminal further includes an optimum route calculation unit that is controlled by the second processor and calculates an optimum route by using the decoded TPEG data.

The terminal of the invention further includes a common memory unit that transmits data between the first processor and the second processor. In the terminal, the first processor may have a Wireless Internet Platform for Interoperability (WIPI) platform or a Binary Runtime Environment for Wireless (BREW) platform.

In the terminal, the memory unit stores the decoded TPEG data. The terminal further includes a second memory unit that stores the decoded TPEG data and is controlled by the second processor.

According to the present invention, a first embodiment of a method for executing a navigation using a DMB-based navigation mobile terminal having a first processor and a second processor is disclosed. The method includes receiving DMB data and determining whether the DMB data is TPEG data under the control of the second processor. The method further includes decoding the TPEG data under the control of the second processor, processing a user's input or executing a route guiding operation under the control of the first processor, determining at the first processor whether there is a request for an optimum route calculation, and executing the optimum route calculation under the control of the first processor by using the decoded TPEG data.

The method of the present invention further includes, after decoding TPEG data, transmitting the decoded TPEG data to the first processor, and storing the decoded TPEG data in a memory unit under the control of the first processor.

According to the present invention, a second embodiment of a method for executing a navigation using a DMB-based navigation mobile terminal having a first processor and a second processor is disclosed. This method includes receiving DMB data and determining whether the DMB data is TPEG data under the control of the second processor. This method further includes decoding the TPEG data under the control of the second processor, processing a user's input or executing a route guiding operation under the control of the first processor, determining at the first processor whether there is a request for an optimum route calculation, transmitting the request for the optimum route calculation from the first processor to the second processor, and executing the optimum route calculation under the control of the second processor by using the decoded TPEG data.

This method of the present invention further includes, after decoding the TPEG data, storing the decoded TPEG data in a memory unit under the control of the second processor. Alternatively, this method further includes, after decoding the TPEG data, transmitting the decoded TPEG data to the first processor, and storing the decoded TPEG data in a memory unit under the control of the first processor.

This method of the present invention further includes, after executing the optimum route calculation, transmitting results of the optimum route calculation to the first processor.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a configuration of a conventional mobile terminal capable of a DMB-based navigation;

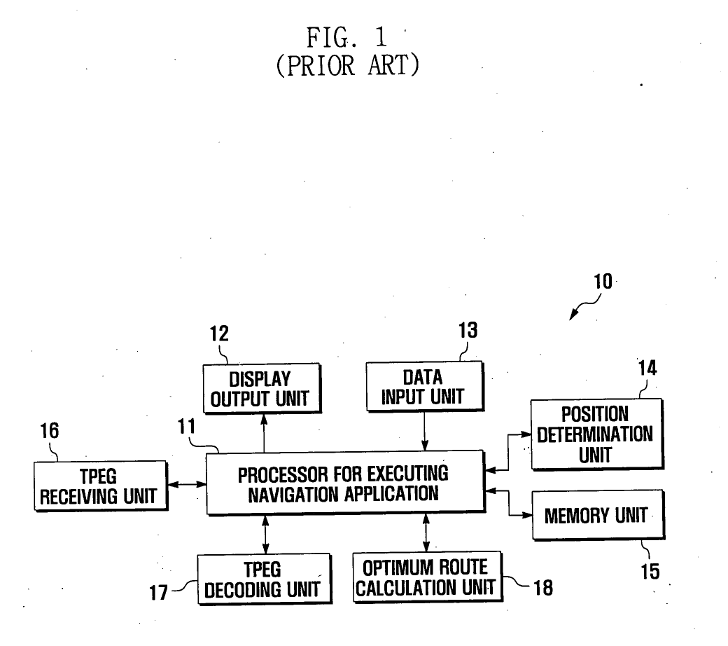

FIG. 2 is a flow diagram illustrating a conventional method for executing a navigation using the terminal in FIG. 1;

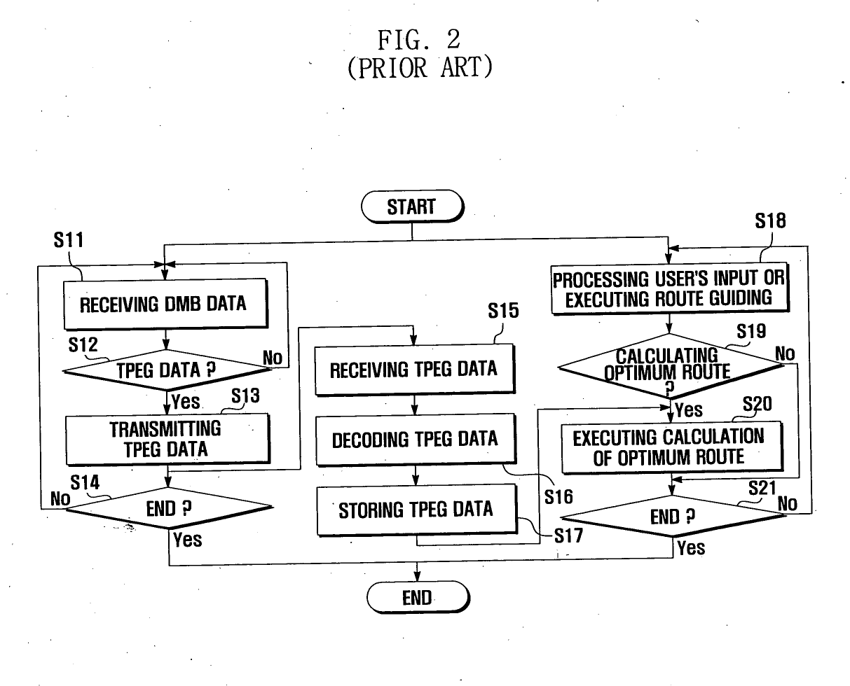

FIG. 3 is a block diagram illustrating a configuration of a DMB-based navigation mobile terminal in accordance with a first embodiment of the present invention;

FIG. 4 is a flow diagram showing a method for executing a navigation using the terminal in FIG. 3;

FIG. 5 is a block diagram illustrating a configuration of a DMB-based navigation mobile terminal in accordance with a second embodiment of the present invention; and

FIG. 6 is a flow diagram illustrating a method for executing a navigation using the terminal in FIG. 5.

### DETAILED DESCRIPTION OF THE PREFERRED EMBODIMENTS

Preferred embodiments of the present invention will now be described more fully hereinafter with reference to the accompanying drawings. This invention may, however, be embodied in many different forms and should not be construed as limited to the preferred embodiments set forth herein. Rather, the principles and features of this invention may be employed in numerous embodiments without departing from the spirit and scope of the present invention.

It is noted that well-known structures and processes are not described or illustrated in detail for the sake of clarity and conciseness.

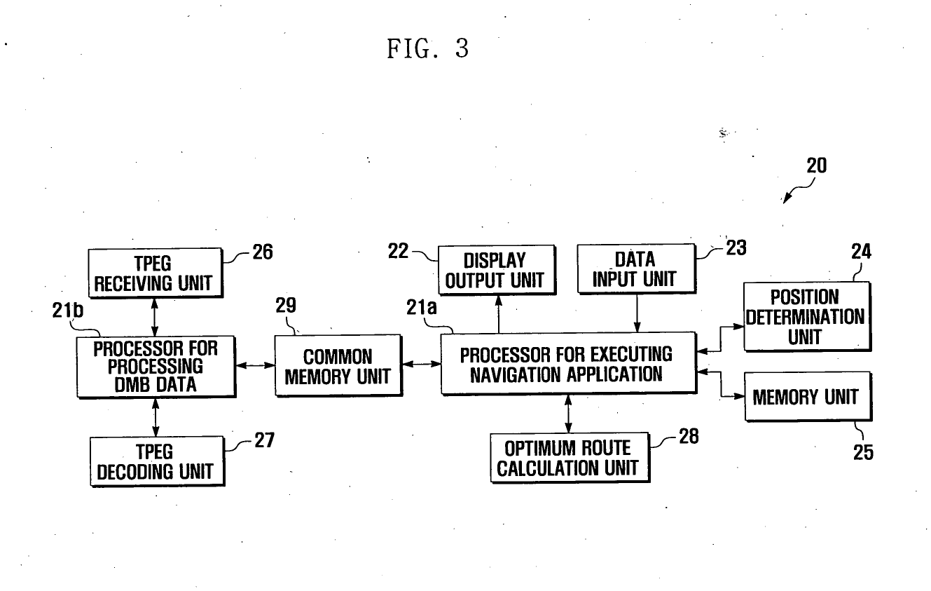

FIG. 3 illustrates, in a block diagram, a configuration of a DMB-based navigation mobile terminal in accordance with a first embodiment of the present invention.

As shown in FIG. 3, the DMB-based navigation mobile terminal 20 includes a processor 21a for executing a navigation application (hereinafter, first processor) and a processor 21b for processing DMB data (hereinafter, second processor). The terminal 20 further includes a display output unit 22, a data input unit 23, a position determination unit 24, a memory unit 25, a TPEG receiving unit 26, a TPEG decoding unit 27, an optimum route calculation unit 28 and a common memory unit 29.

The first processor 21a and the second processor 21b control the operation of a variety of components in the terminal 20. Particularly, the first processor 21a controls the processing of a user's input, the execution of a route guiding operation and the calculation of an optimum route. The second processor 21b controls the reception and decoding of TPEG data. Since the second processor 21b separately executes the decoding of the TPEG data, it is possible to reduce a processing load of the first processor 21a. A WIPI platform or a BREW platform as well known in the art may be equipped with the first processor 21a.

The display output unit 22 provides visual information, such as map data, a user's current position and an optimum route, on a screen under the control of the first processor 21a.

The data input unit 23 receives input signals through user's operation such as a navigation request and then sends the input signals to the first processor 21a. The user's navigation request may be a request for an ordinary route guiding or a request for an optimum route using traffic information in the TPEG data.

The position determination unit 24 determines the user's current position by using a GPS as well known in the art and then transmits it to the first processor 21a. The user's current position, together with the map data, is displayed on the display output unit 22.

The memory unit 25 saves and manages various data such as map data for the route guiding, TPEG data for calculation of the optimum route and the user's input data.

The TPEG receiving unit 26 receives repeatedly transmitted real-time DMB data and then determines whether the received DMB data is TPEG data. The received TPEG data is sent to the TPEG decoding unit 17 under the control of the second processor 21b. The TPEG receiving unit 26 may be an independent unit or alternatively be a DMB middleware existing in the second processor 21b.

The TPEG decoding unit 27 decodes the received TPEG data under the control of the second processor 21b. The TPEG decoding unit 27 may be a TPEG decoding task existing in the second processor 21b.

The optimum route calculation unit 28 is controlled by the first processor 21a and calculates an optimum route by using the decoded TPEG data at a user's request. The optimum route calculation unit 28 may be an optimum route calculating task existing in the first processor 21a.

The common memory unit 29 transmits data, such as the decoded TPEG data, between the first and second processors 21a and 21b.

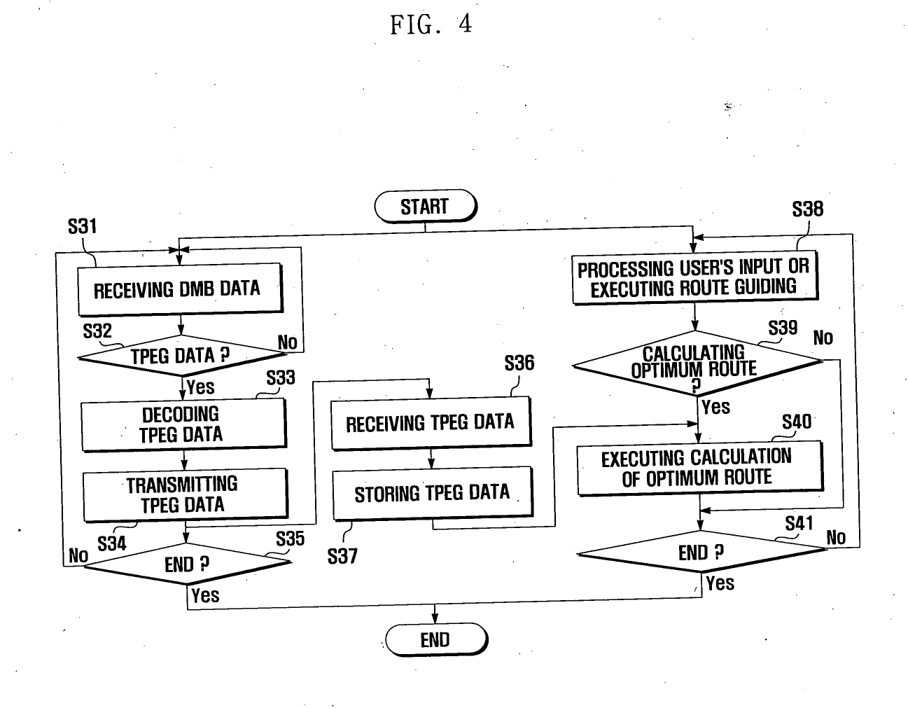

FIG. 4 is a flow diagram showing a method for executing a navigation using the terminal in FIG. 3.

Referring to FIGS. 3 and 4, at the outset of the navigation, the TPEG receiving unit 26 receives the repeatedly transmitted real-time DMB data under the control of the second processor 21b (S31). The TPEG receiving unit 26 determines whether the received DMB data is TPEG data (S32). If the received DMB data is not TPEG data, then steps S31 and S32 are repeated.

If the received DMB data are TPEG data, the TPEG decoding unit 27 decodes the TPEG data under the control of the second processor 21b (S33), and then transmits the decoded TPEG data to the first processor 21a through the common memory unit 29 (S34). The second processor 21b determines whether to finish the navigation (S35). If the decision is “yes”, the navigation ends. If the decision is “no”, then steps S31 to S35 are repeated.

After receiving the TPEG data in step S34 (S36), the first processor 21a stores the received TPEG data in the memory unit 25 (S37).

At the outset of the navigation, the first processor 21a processes a user's input transmitted by the data input unit 23, or executes a route guiding operation while displaying the user's current position and map data on the display output unit 22 (S38). Additionally, the first processor 21a determines whether a request for the calculation of the optimum route is inputted from the data input unit 23 (S39).

When there is a request for the calculation, the optimum route calculation unit 28 executes a calculation of the optimum route under the control of the first processor 21a by using the TPEG data stored in the memory unit 25 (S40). The first processor 21a exhibits calculation results on the display output unit 22. After the calculation, or when there is no request for the calculation, the first processor 21a determines whether to finish the navigation (S41). If the decision is “yes”, the navigation ends. If the decision is “no”, then steps S38 to S41 are repeated.

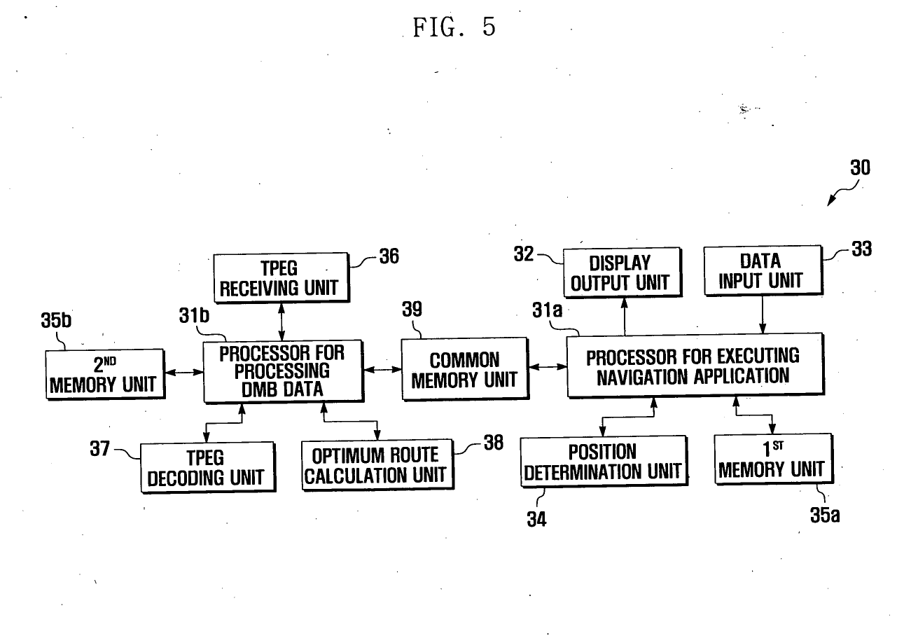

FIG. 5 illustrates a configuration of a DMB-based navigation mobile terminal in accordance with a second embodiment of the present invention.

In FIG. 5, an optimum route calculation unit 38 is controlled by a second processor 31b, instead of a first processor 31a. This is one of the distinctions between the second embodiment and the above-discussed first embodiment. The terminal 30 further includes a second memory unit 35b controlled by the second processor 31b as well as a first memory unit 35a controlled by the first processor 31a. However, the terminal 30 may have only the first memory unit 31a without the second memory unit 31b.

An optimum route calculation unit 38 calculates an optimum route at a user's request by using the TPEG data decoded in a TPEG decoding unit 37. The optimum route calculation unit 38 may be an optimum route calculating task existing in the second processor 31b.

While the first memory unit 35a stores and manages the map data for the route guiding and the user's input data, the second memory unit 35b stores and manages TPEG data for the optimum route calculation.

Other elements of the DMB-based navigation mobile terminal 30 that are not discussed here are the same as those of the first embodiment discussed above.

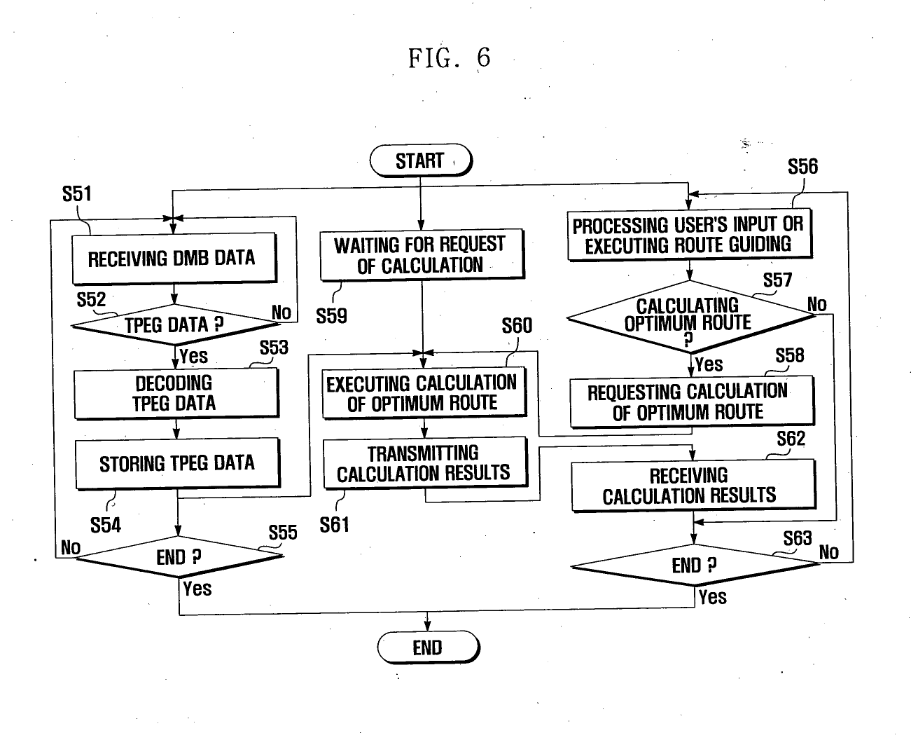

FIG. 6 illustrates a method for executing a navigation using the terminal in FIG. 5.

Referring to FIGS. 5 and 6, at the outset of the navigation, the TPEG receiving unit 36 receives the real-time DMB data under the control of the second processor 31b (S51). The TPEG receiving unit 36 determines whether the received DMB data is TPEG data (S52). If the received DMB data are not TPEG data, then steps S51 and S52 are repeated.

If the received DMB data is TPEG data, the TPEG decoding unit 37 decodes the TPEG data under the control of the second processor 31b (S53). The second memory unit 35b stores the decoded TPEG data (S54). When there is no second memory unit 35b, the decoded TPEG data may be transmitted to the first processor 31a through the common memory unit 39 and then stored in the first memory unit 35a. The second processor 31b determines whether to finish the navigation (S55). If the decision is “yes”, the navigation ends. If the decision is “no”, then steps S51 to S55 are repeated.

At the outset of the navigation, the first processor 31a processes a user's input transmitted by the data input unit 33, or executes a route guiding operation while exhibiting the user's current position and the map data on the display output unit 32 (S56). The first processor 31a determines whether a request for the calculation of the optimum route is inputted from the data input unit 33 (S57).

When there is a request for the calculation, the first processor 31a requests the optimum route calculation to the second processor 31b (S58). The second processor 31b waits for the request for the optimum route calculation (S59). Once having received the request, the second processor 31b controls the optimum route calculation unit 38. Under the control of the second processor 31b, the optimum route calculation unit 38 executes a calculation of the optimum route by using the TPEG data stored in the second memory unit 35b (S60).

The second processor 31b transmits calculation results of the optimum route to the first processor 31a through the common memory unit 39 (S61). The first processor 31a receives the calculation results (S62) and displays them on the display output unit 32. After receiving the calculation results, or when there is no request for the calculation at step S57, the first processor 31a determines whether to finish the navigation (S63). If the decision is “yes”, the navigation ends. If the decision is “no”, then steps S58 to S63 are repeated.

As discussed above, in the mobile terminal and the method for DMB-based navigation according to the present invention, the receiving and decoding of the TPEG data, with higher processing load, are executed in the separate processor for processing the DMB data. Additionally, the optimum route calculation may be executed in the separate DMB data processor. Accordingly, the present invention may reduce the processing load of the existing processor for executing the navigation application. Also, the present invention may decrease a response time to a user's navigation request and improve a user's convenience.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A Digital Multimedia Broadcasting (DMB)-based navigation mobile terminal comprising:
a data input unit for receiving input signals from a user;
a position determination unit for determining a current position of the user;
a memory unit for storing map data;
a first processor for processing the input signals and controlling a route guiding operation;
a Transport Protocol Experts Group (TPEG) receiving unit for receiving TPEG data;
a TPEG decoding unit for decoding the TPEG data;
a second processor for controlling the receiving and the decoding of the TPEG data; and
a display output unit for displaying the user's current position and the map data under the control of the first processor.

2. The terminal of claim 1, further comprising:
an optimum route calculation unit controlled by the first processor, for calculating an optimum route by using the decoded TPEG data.

3. The terminal of claim 1, further comprising:
an optimum route calculation unit controlled by the second processor, for calculating an optimum route by using the decoded TPEG data.

4. The terminal of claim 1, further comprising:
a common memory unit for transmitting data between the first processor and the second processor.

5. The terminal of claim 1, wherein the first processor has a Wireless Internet Platform for Interoperability (WIPI) platform or a Binary Runtime Environment for Wireless (BREW) platform.

6. The terminal of claim 1, wherein the memory unit stores the decoded TPEG data.

7. The terminal of claim 1, further comprising:
a second memory unit, controlled by the second processor, for storing the decoded TPEG data.

8. A method for executing a navigation using a Digital Multimedia Broadcasting (DMB)-based navigation mobile terminal having a first processor and a second processor, the method comprising:
receiving DMB data and determining whether the DMB data is TPEG data under the control of the second processor;
decoding the Transport Protocol Experts Group (TPEG) data under the control of the second processor;
processing a user's input or executing a route guiding operation under the control of the first processor;
determining at the first processor whether there is a request for an optimum route calculation; and
executing the optimum route calculation under the control of the first processor by using the decoded TPEG data.

9. The method of claim 8, further comprising:
transmitting decoded TPEG data to the first processor after decoding the TPEG data; and
storing the decoded TPEG data in a memory unit under the control of the first processor.

10. A method for executing a navigation using a Digital Multimedia Broadcasting (DMB)-based navigation mobile terminal having a first processor and a second processor, the method comprising:
receiving DMB data and determining whether the DMB data is TPEG data under the control of the second processor;
decoding the Transport Protocol Experts Group (TPEG) data under the control of the second processor;
processing a user's input or executing a route guiding operation under the control of the first processor;
determining at the first processor whether there is a request for an optimum route calculation;
transmitting the request for the optimum route calculation from the first processor to the second processor; and
executing the optimum route calculation under the control of the second processor by using the decoded TPEG data.

11. The method of claim 10, further comprising:
storing, after decoding the TPEG data, the decoded TPEG data in a memory unit under the control of the second processor.

12. The method of claim 10, further comprising:
transmitting, after decoding the TPEG data, the decoded TPEG data to the first processor; and
storing the decoded TPEG data in a memory unit under the control of the first processor.

13. The method of claim 10, further comprising:
transmitting, after executing the optimum route calculation, results of the optimum route calculation to the first processor.
